(19) United States
(12) Patent Application Publication
(10) Pub. No.: US 2004/0230867 A1
(43) Pub. Date: Nov. 18, 2004

(54) Method and system of using high-level code for independent debugging of a processor

(76) Inventor: Ramin Soheili, San Francisco, CA (US)

Correspondence Address: MAYER, BROWN, ROWE & MAW LLP, 190 SOUTH LASALLE ST, CHICAGO, IL, 60603-3441, US

(21) Appl. No.: 10/438,762

(22) Filed: May 15, 2003

(51) Int. Cl. H04L 1/22

(52) U.S. Cl. 714/25

(57) ABSTRACT

A method and system for debugging a digital signal processor includes a high-level code that reads processor data stored on a storage device on the processor, converts the processor data into a predetermined format and then compares the processor data to certain compare data to locate differences in the data.

### FIELD

The present invention generally relates to software development for programmable processors, and more particularly, to a method for optimizing the debugging of digital signal processors (DSPs).

### BACKGROUND

The debugging process for software developed for DSPs is a very time-intensive process in conventional software environments. Currently, even with a user-friendly Graphical User Interface (GUI), a software developer must follow the following process to debug millions of occurrences of data. First, the developer sends initial data from a computer to a DSP and receives response data to the initial data where that response data is stored on the DSP. Typically this data is stored in registers or memory banks. Secondly, that information is then sent back to the GUI where the software developer must compare the response data received to a correct set of data. This comparison is done either manually by the software developer or through a time-intensive comparison program. This is typically done through a debugger tool located on the computer that sends a command to read the register data out from the processor in order to send back the data to the GUI for the software developer to locate discrepancies between that data and a correct set of data. This standard approach to obtaining debugger information (without stopping a processor) uses PRINT statements in the application code to verify that a particular point of program execution, such as a function entry, has been reached. Once the register information is printed, the software developer must then manually go through and debug any errors. Again, all of this is performed using a low-level programming environment, such as assembly level language, located on the computer.

This is a very time-consuming process in view of the sheer volume of data that must be processed through a DSP. Consider the fact that, in one example for audio processing, at a 441000 sampling rate/second (for 16 bit samples), there are 88,200 bytes of data/second. With an average song lasting four minutes, this is a very large amount of data that must be processed. Even more difficult is stereo sound that has double the data. Thus, while certain software development tools have brought together, on one window (or GUI), different views to compare the differences in the data, the actual time needed to review all the differences between data is too time-consuming.

An additional limitation in DSP debugging are the errors due to the precision of the conversion of a signal into its digital representation. This precision is limited by the bits available in a signal's digital representations. For example, in an 8 bit precision, a smooth varying analog signal can only be represented as a “stepping” signal due to the limited 8 bit precision. While a common problem to DSP, the only reliable way to calculate how precise a DSP conversion has been is to implement the conversion and then test (debug) it. Debugging due to imprecision is another lengthy task. While larger bits (16 or 24 bits) may be used to improve precision, using larger bits increases processing time, requires additional storage and additional processing power.

A need therefore exists for a method that relieves the amount of time needed to debug DSP software and to provide better precision.

### SUMMARY OF THE INVENTION

An embodiment of the present invention provides for a method for debugging, by a host system, processor data stored on a processor. The method includes generating by the host system a test data to send to the processor for processing by the processor. The host system also generates a compare data to compare to the processor data, once the processor data is received from the processor. The test data is transmitted to the processor and the processor, in response thereto, generates the processor data and stores the processor data in a storage device on the processor. The host system has processor development tools on the host system for communicating with the processor. Then a high-level code, located on the host system, reads the processor data from the storage device and compares the processor data to the compare data independently of the processor development tools to determine the differences between the data in order to debug the processor data.

A computer-readable medium that has executable code to provide the method for debugging described above is also described herein.

### BRIEF DESCRIPTION OF THE DRAWINGS

A more complex appreciation of the invention and many of the advantages thereof will be readily obtained as the same becomes better understood by references to the detailed description when considered in connection with the accompanying drawings, wherein:

FIG. 1 is a block diagram view of an embodiment of the system of the present invention;

FIG. 2 is a block diagram view of a further embodiment of the system of the present invention;

FIG. 3 is a screen view of an embodiment of a graphical user interface located on the host system of the present invention;

FIG. 4 is an embodiment of the high-level code of the present invention;

FIG. 5 is a flow chart view of an embodiment of the method of the present invention; and

FIG. 6 is a block diagram view of an embodiment of the host system of the present invention.

### DETAILED DESCRIPTION

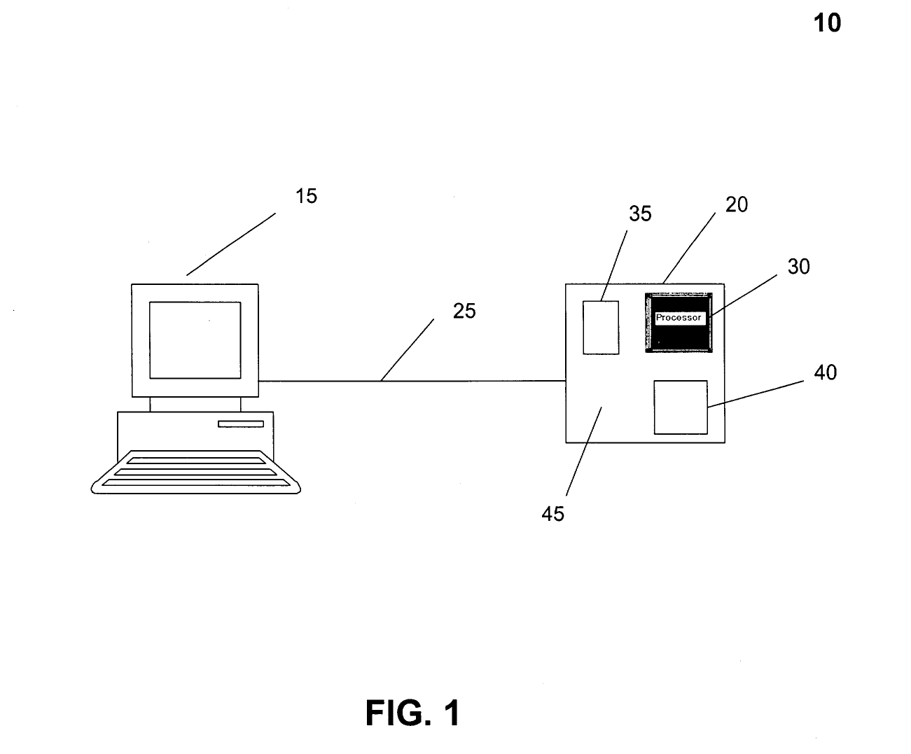

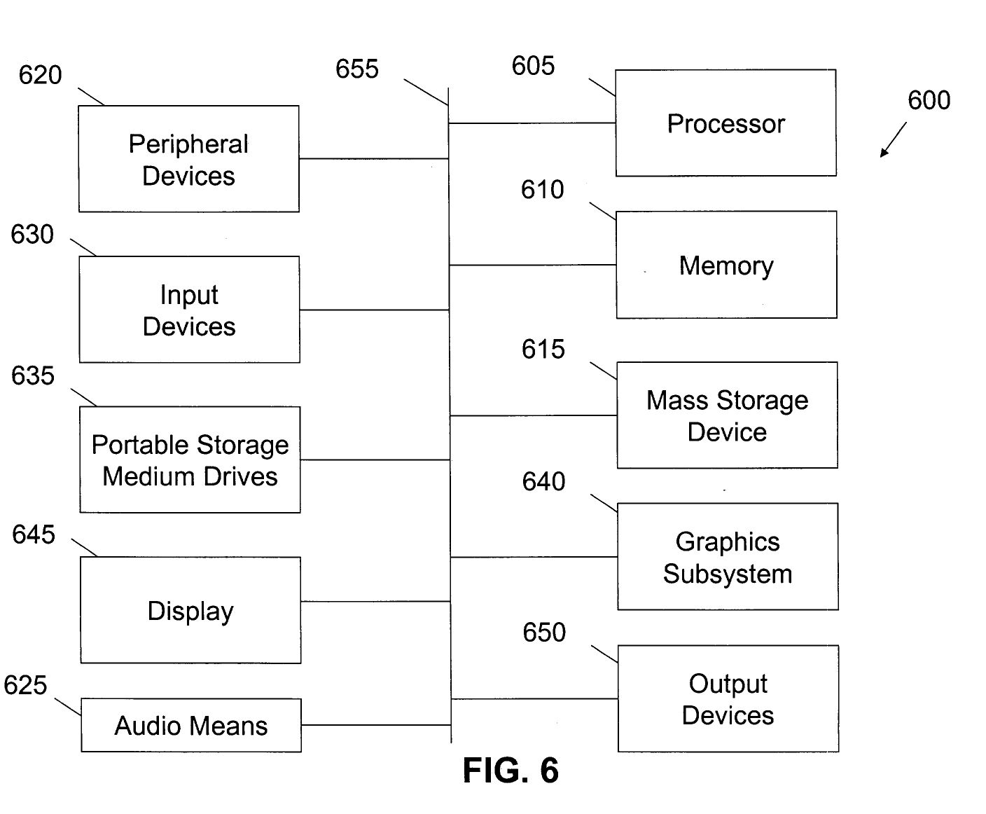

Turning now to the detailed figures, FIG. 1 is a block diagram view of an embodiment of the system of the present invention. In FIG. 1, the system 10 includes a host system 15 and emulator 20 and a communications device 25 connecting the host system 15 to the emulator 20. The host system 15, in one embodiment, is a general computer system such as the embodiment of the computer system described in detail below in FIG. 6. The emulator 20 is a standard in-circuit emulator such as the Texas Instrument XDS510 emulator manufactured by Texas Instruments, Inc. The system 10 is a system that is used to develop and test software embedded in the processor 30 located on the emulator 20. The processor 30 may be any processor, and in one embodiment, is a DSP. Alternatively, in other embodiments, the processor may be a microprocessor, a field programmable gate array, an application specific integrated circuit, or any other type of integrated circuit device. Also on the emulator 20 is a microprocessor 35 that controls the communications and circuitry between the host system 15 and the emulator 20. It is understood that the microprocessor may be a microcontroller in alternative embodiments, or, in other embodiments, may be any dedicated hardware that controls electronic signals between devices. Still on the emulator 20 is a storage device 40 that is any type of memory device such as the storage devices discussed in FIG. 6 below. Additional circuitry 45 exists on the emulator 20 in order to communicate between devices located on the emulator 20 as well as to communicate with the host system 15. The communication means 25 between the host system 15 and the emulator 20 is any type of cable or other transmitting means (wire or wireless) to exchange data between the emulator 20 and the host system 15. In one embodiment, the communication means 25 is a SCSI cable as is well known in the art.

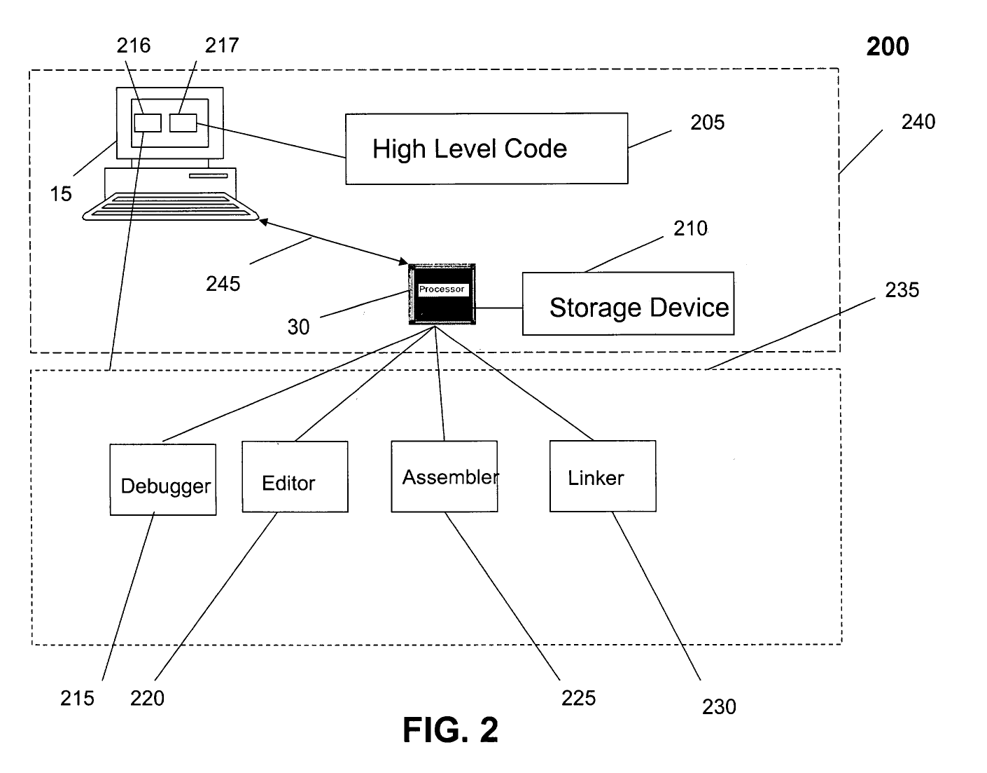

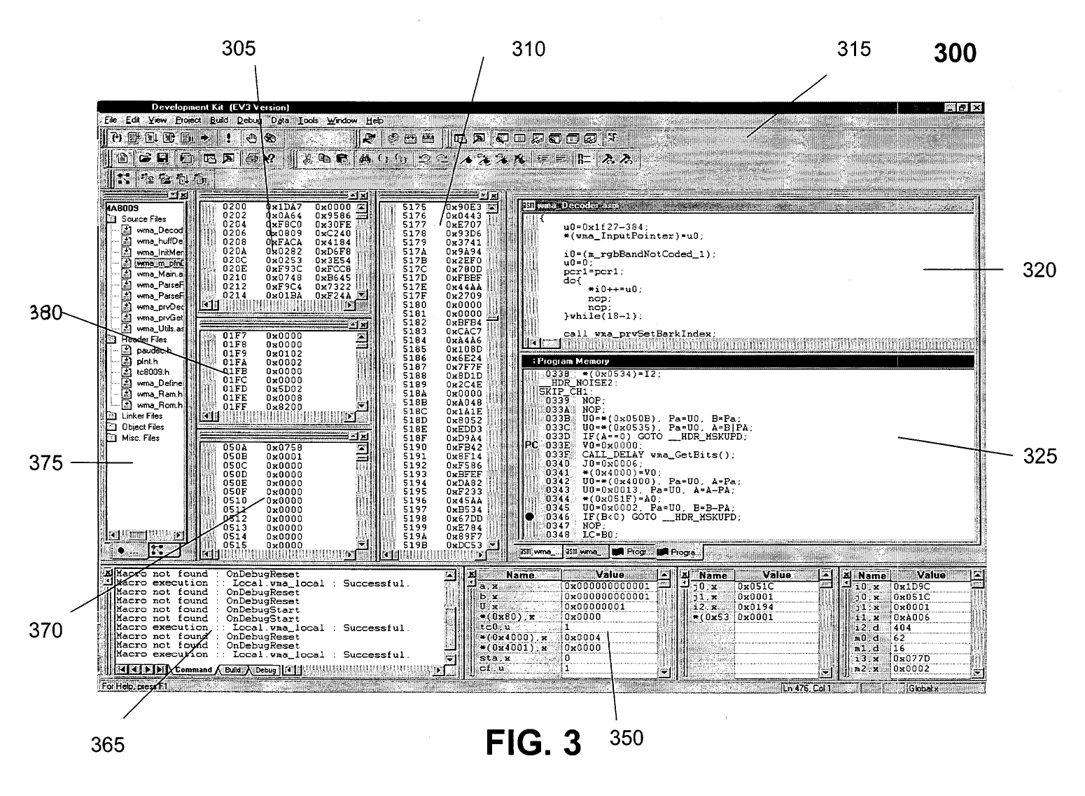

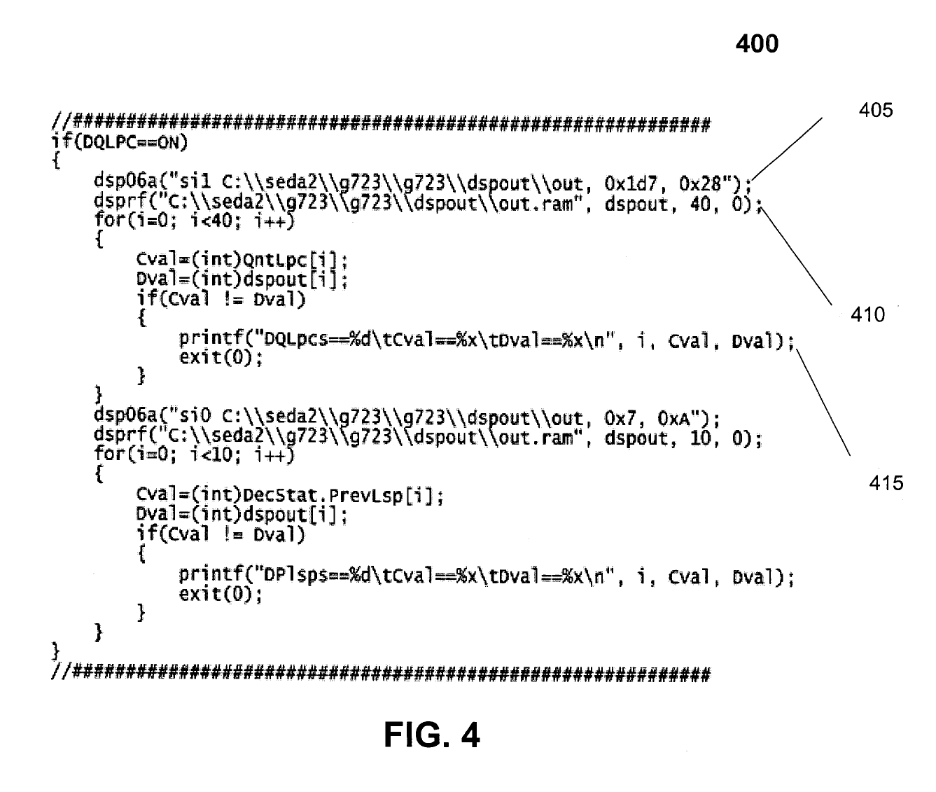

In operation, the host system 15 contains a graphical user interface (see embodiment of FIG. 3 below) that enables a user, such as a program developer in one embodiment, to view communications between the host system 15 and the processor 30 in order to develop software for the processor 30. The host system 15 would generate a test data (not shown) to send through the communication means 25 to the emulator 20 to be received by the processor 30. The host system 15 also generates a compare data (not shown) that is a value of the correct data value and maintains the compare data on the host system 15. Once the test data is transmitted through the communication means 25 to the emulator 20 and to the processor 30, the processor 30 generates a processor data based on the software code programmed and embedded on the processor (the code being debugged). It is noted that the processor also has certain processor developmental tools (FIG. 2) that include, for example, an editor, assembler, linker and debugger that are typically placed on the host system when received in software format from a manufacturer. These processor development tools are used in the GUI on the host system 10 to interface with the processor 30. However, the debugger application located on the host system 15 is not used in the debugging of the processor 30 in this embodiment of the invention. This is because, as will be explained in more detail below, a high-level code located on the host system 15 more efficiently and expediently performs the debugging separate, and independent from, the debugger or any other processor development tools located on the processor. It is this independence from the debugger that alleviates the needs in the art of the time-consuming process of reading the data from the processor onto the GUI and having to manually compare the compare data to the processor data. The high-level code (e.g., the embodiment of FIG. 4) alleviates this problem by performing the comparison independent of any low-level programming language or processor development tools. The high-level code therefore reads the processor data from the storage device and compares the processor data to the compare data independently of the processor development tools to determine differences between the data to debug the processor data. The high-level code further converts the processor data into a format that enables the comparison between the processor data and the compare data after reading the processor data from the storage device and before comparing the processor data to the compare data. The high-level code (FIG. 4) may be written in any high-level programming language, and in one embodiment is written in a C programming language. In an alternative embodiment, the high-level code is written in a C++ programming language. Still further, in another alternative embodiment, the high-level code is written in Visual. The high-level code may be stored on any type of computer readable medium or memory device as more fully described in FIG. 6 below. This high-level code independence from the processor developmental tools has an added benefit with regard to the precision analysis problem discussed above. That is, precision of the signal conversion into its digital representation is enhanced by the methodology of the present invention since the processing time is reduced using the methodology of the present invention, even for floating point formats (as such formats are well known in the art). This is because floating point formats (which are more accurate) may be used, rather than fixed point formats, due to the independent, high-level code debugging of the present invention. Thus, although the data is stored in a floating point format, the processing speed for debugging the DSP may be maintained at a higher speed using an embodiment of the high-level code of the present invention to compare the processor data to the compare data independently of the processor developmental tools.

FIG. 2 is a block diagram view of an embodiment of the system of the present invention. In FIG. 2, the host system 15 is shown to contain the high-level code 205 (that will be further shown in FIG. 4 below) that will interact independently of the development tools 216 with the storage device 210 on processor 30. Thus, in box 240, the high-level code 205 is viewed to independently interact with the storage device 210 to read processor data (not shown) from the storage device 210, then convert that processor data into a format that enables comparison between the processor data and compare data (in host system 15). In one embodiment, the high-level code would be displayed in GUI window 217 which is independent and apart from the GUI window 216 for the processor developmental tools 216. It is understood that although only two GUI windows 216, 217 are shown in this embodiment, other embodiments may have a different number of GUI's. The format conversion may be, for example, a conversion into a binary format. In alternative embodiments, character, pixel, or integer formats may also be used. After the conversion, the high-level code 205 will compare the processor data to the compare data to determine any differences between the data. Should a difference exist, a correction will need to be performed to debug the software program. Should the two data be equal, then there is no reason to debug the program. By performing this comparison independent of the processor development tools 235 (216), the system 200 benefits from a much more user-friendly debugging process. That is, a program developer is able to much more efficiently and quickly work in a high-level programming language such as C, C++ or the like, rather than in a low-level programming language (e.g., assembly language) that may take more time and is more tedious to debug than a high-level programming language that debugs automatically using code. Thus, while the debugger 215 (in the process development tools) is able to debug in a low level program, use of the high-level code 205 independently with the processor to interact with the storage device 210 results in a much more time-efficient and simplified process for program developers. Thus, although an Editor 220, Assembler 225 and Linker 230, as well as the Debugger, exist as development tools 235 on the host system, the high-level code is able to act independently, through a communication means 245, to interact with the storage device in order to locate differences between the processor data and compare data. Even further, the benefits of higher precision with the floating point format may be used with this embodiment of the debugging methodology to increase processing time. Still further, even with fixed point formats, processing time is further simplified by the methodology of the present invention.

FIG. 3 is a screen view of an embodiment of a graphical user interface (GUI) to be used on the host system. In FIG. 3, a plurality of windows exist for developing and testing software on a processor. The GUI 300 may be a standard GUI such as a GUI known as SWEEP offered by SEDA Solutions Corp. of San Francisco, Calif. The primary difference, however, between the SWEEP GUI and the system 300 is that, in this embodiment, the high-level code is incorporated in the GUI 300 to read the processor data, convert the processor data to the same format as the compare data, and compare the two data for any differences. In FIG. 3, a project directory window 375 is used to define information concerning a current project or certain source files. A file editor window 320 is where the files are opened and edited. It is in this file editor window that the high-level code may be opened and edited. A program memory browser window 325 shows the status of the storage device on the processor. Data that is in the storage device is fetched and displayed within the program memory browser window 325 in different formats. Register browser windows 310, 305, 380 and 370 display register data fetched from the processor and displayed in the appropriate window. Status/debugger windows 350 allow to view the command sent to the processor as well as the information sent back from the processor. The status of the commands are shown in window 365.

FIG. 4 is a screen view of an embodiment of the high-level code of the present invention. In FIG. 4, three specific lines of high-level code (in this embodiment C code) are depicted. At line 405, the processor data is read from the processor into a storage device on the processor. At line 410, the processor data is converted to the same format as the compare data. Then at line 415, a print function exists if Cval is not equal to Dval, where the Cval corresponds to the processor data and the Dval corresponds to the compare data. It is understood that a number of different high-level programming languages can be used to implement the methodology of the present invention, as well as a different number (more or less) of lines of code than that depicted in FIG. 4, in alternative embodiments.

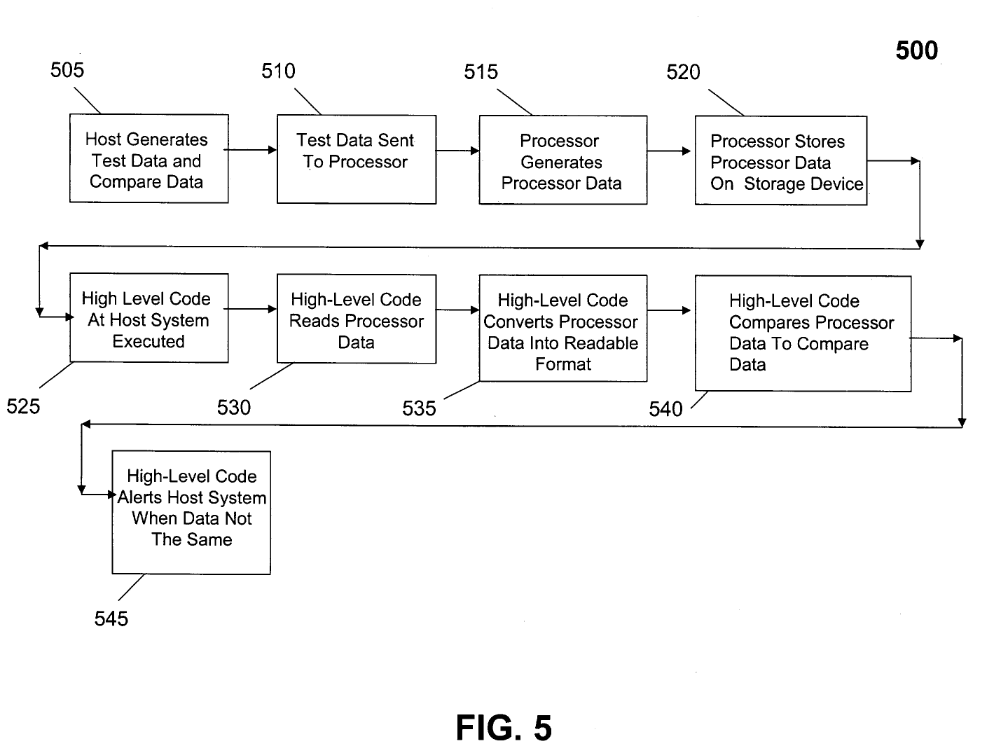

FIG. 5 is a flow chart of an embodiment of the method of the present invention. In FIG. 5, at step 505, the host system first generates a test data as well as compare data. The host system then sends, through a communication means, the test data to the processor at step 510. Then at step 515, the processor generates processor data by processing the test data through the appropriate application. Then at step 520, the processor stores the processor data on a storage device on the processor. At step 525, the high-level code of FIG. 4 is executed at the host system to first read the processor data stored at the storage system at step 530. Then the high-level code converts the processor data into a readable format between the processor data and the compare data at step 535. At step 540, the high-level code compares the processor data to the compare data and then alerts the host system when the data is not the same at step 545, typically through a print statement. The error may be due to any one of a number of bugs, that may include inaccurate precision.

FIG. 6 is a block diagram of a computer system 600 used for performing an embodiment of the present invention. The computer system 600 is, in one embodiment, the host system of the present invention. The computer system 600 includes a processor 605 for executing program instructions stored in a memory 610. In some embodiments, processor 605 includes a single microprocessor, while in others, processor 605 includes a plurality of microprocessors to define a multi-processor system. The memory 610 stores instructions and data for execution by processor 605, including instructions and data for performing the methods described above. Depending on the extent of software implementation in computer system 600, the memory 610 stores executable code when in operation (e.g., the high-level code). The memory 610 includes, for example, banks of read-only memory (ROM), dynamic random access memory (DRAM) as well as high-speed cache memory.

Still in FIG. 6, within computer system 600, an operating system comprises program instruction sequences that provide services for accessing, communicating with, and controlling auction server computer system 600. The operating system provides a software platform upon which application programs may execute, in a manner readily understood by those skilled in the art. The computer system 600 further comprises one or more applications having program instruction sequences for providing a reward for displaying content over a data network.

Further in FIG. 6, the computer system 600 incorporates any combination of additional devices. These include, but are not limited to, a mass storage device 615, one or more peripheral devices 620, an audio means 625, one or more input devices 630, one or more portable storage medium drives 635, a graphics subsystem 640, a display 645, and one or more output devices 650. The various components are connected via an appropriate bus 655 as known by those skilled in the art. In alternative embodiments, the components are connected through other communications media known in the art. In one example, processor 605 and memory 610 are connected via a local microprocessor bus; while mass storage device 615, peripheral devices 620, portable storage medium drives 635, and graphics subsystem 640 are connected via one or more input/output buses.

Continuing in FIG. 6, mass storage device 615 is implemented as fixed and/or removable medium, for example, as a magnetic, optical, or magneto-optical disk drive. The drive is preferably a non-volatile storage device for storing data and instructions for use by processor 605. In some embodiments, mass storage device 615 stores client and server information, code for carrying out methods in accordance with exemplary embodiments of the invention (e.g., the high-level code), and computer instructions for processor 605. In other embodiments, computer instructions for performing methods in accordance with exemplary embodiments of the invention also are stored in processor 605. The computer instructions are programmed in a suitable language such as Java, C, Visual or C++.

In FIG. 6, the portable storage medium drive 635, in some embodiments, operates in conjunction with a portable non-volatile storage medium, such as a floppy disk, CD-ROM, or other computer-readable medium, to input and output data and code to and from the computer system 600. In some embodiments, methods performed in accordance with exemplary embodiments of the invention are implemented using computer instructions that are stored on such a portable medium and input to the computer system 600 via portable storage medium drive 635.

In FIG. 6, the peripheral devices 620 include any type of computer support device, such as an input/output (I/O) interface, to add functionality to computer system 600. The peripheral devices also include input devices to provide a portion of a user interface and may include an alphanumeric keypad or a pointing device such as a mouse, a trackball, a stylus, or cursor direction keys. The I/O interface comprises conventional circuitry for controlling input devices and performing particular signal conversions upon I/O data. The I/O interface may include, for example, a keyboard controller, a serial port controller, and/or digital signal processing circuitry.

In FIG. 6, the graphics subsystem 640 and the display 645 provide output alternatives of the system. The graphics subsystem 640 and display 645 include conventional circuitry for operating upon and outputting data to be displayed, where such circuitry preferably includes a graphics processor, a frame buffer, and display driving circuitry. The display 645 may include a cathode ray tube (CRT) display, a liquid crystal display (LCD), or other suitable devices. The display 645 preferably can display at least 256 colors. The graphics subsystem 640 receives textual and graphical information and processes the information for output to the display 645. In one embodiment, the display would be used to display the GUI of FIG. 3. A video card in the computer system 600 also comprises a part of graphics subsystem 640 and also preferably supports at least 256 colors. For optimal results in viewing digital images, the user should use a video card and monitor that can display the True Color (24 bit color) setting. This setting enables the user to view digital images with photographic image quality.

In FIG. 6, audio means 625 preferably includes a sound card that receives audio signals from a peripheral microphone. In addition, audio means 625 may include a processor for processing sound. The signals can be processed by the processor in audio means 625 of computer system 600 and passed to other devices as, for example, streaming audio signals.

In some embodiments, programs for performing methods in accordance with exemplary embodiments of the invention are embodied as computer program products. These generally include a storage medium or medium having instructions stored thereon used to program a computer to perform the methods described above. Examples of suitable storage medium or media include any type of disk including floppy disks, optical disks, DVDs, CD ROMs, magnetic optical disks, RAMs, EPROMs, EEPROMs, magnetic or optical cards, hard disk, flash card, smart card, and other medium.

Stored on one or more of the computer readable medium, the program includes software for controlling both the hardware of a general purpose or specialized computer or microprocessor. This software also enables the computer or microprocessor to interact with a human or other mechanism utilizing the results of exemplary embodiments of the invention. Such software includes, but is not limited to, device drivers, operating systems and user applications. Preferably, such computer readable medium further include software for performing the methods described above.

In certain other embodiments, a program for performing an exemplary method of the invention or an aspect thereof is situated on a carrier wave such as an electronic signal transferred over a data network. Suitable networks include the Internet, a frame relay network, an ATM network, a wide area network (WAN), or a local area network (LAN). Those skilled in the art will recognize that merely transferring the program over the network, rather than executing the program on a computer system or other device, does not avoid the scope of the invention.

It will be understood that the above-described apparatus and method are merely illustrative of applications of the principles of this invention and many other embodiments and modifications may be made without departing from the spirit and scope of the invention as defined in the claims.

What is claimed is:

1. A method for debugging processor data by a host system, the processor data received from a processor, comprising:
generating, by the host system, a test data to send to the processor for processing by the processor, the host system further generating a compare data to compare to the processor data, once received, the host system having processor developmental tools for communicating with the processor;
transmitting the test data to the processor;
generating the processor data by the processor, the processor data being stored in a storage device on the processor; and
providing a high-level code to debug the processor data, the high-level code residing on the host system and performing the steps of:
reading the processor data from the storage device; and
comparing the processor data to the compare data independently of the processor developmental tools to determine differences between the data to debug the processor data.

2. The method of claim 1, wherein the high-level code is a C programming language.

3. The method of claim 1, wherein the high-level code is a C++ programming language.

4. The method of claim 1, wherein the high-level code further performs the steps of:
converting the processor data into a format that enables comparison between the processor data and the compare data after the reading step and before the comparing step.

5. The method of claim 1, wherein the processor developmental tools further comprise an editor, a linker, and an assembler.

6. The method of claim 1, wherein the processor is a digital signal processor.

7. The method of claim 1, wherein the processor is a microprocessor.

8. A computer-readable medium for storing a high-level code implemented for debugging processor data received from a processor, the processor data being transmitted from a processor to a host system in response to a test data being sent from the host system to the processor, the host system having thereon processor developmental tools for communicating with the host system, the host system generating a compare data to compare the processor data to the compare data, the high-level code being executable to perform the computer-effected steps of:
reading the processor data from the processor; and
comparing the processor data to the compare data independently of the processor developmental tools to determine differences between the data to debug the processor data.

9. The computer-readable medium of claim 8, wherein the high-level code is a C programming language.

10. The computer-readable medium of claim 8, wherein the high-level code is a C++ programming language.

11. The computer-readable medium of claim 8, wherein the high-level code further performs the steps of:
converting the processor data into a format that enables comparison between the processor data and the compare data.

12. A system for debugging a processor, comprising:
the processor, the processor in communication with a host system through processor developmental tools on the host system, the processor receiving a test data from the host system and generating processor data in response thereto, the processor data being stored on the processor in a storage device; and
a host system, the host system comprising a high-level programming editor to develop high-level code, the host system generating the test data to send to the processor for processing on the processor, the high-level code being executable to perform the steps of:
reading the processor data from the storage device on the processor; and
comparing the processor data to the compare data independently of the processor developmental tools to determine differences between the data to debug the processor data.
